(19) United States
(12) Patent Application Publication
(10) Pub. No.: US 2023/0337623 A1
(43) Pub. Date: Oct. 26, 2023

(54) INVERTIBLE AND HYGIENIC LITTER BOX

(71) Applicant: Blake Ranno, Old Tappan, NJ (US)

(72) Inventor: Blake Ranno, Old Tappan, NJ (US)

(21) Appl. No.: 18/138,205

(22) Filed: Apr. 24, 2023

Related U.S. Application Data
(60) Provisional application No. 63/333,608, filed on Apr. 22, 2022.

(51) Int. Cl. A01K 1/01

(52) U.S. Cl. CPC A01K 1/0114

(57) ABSTRACT

Described herein is a litter box that may be rotated or inverted about an arcuate surface thereby allowing the litter to be cleaned without throwing away all of the litter. Further, this apparatus prevents a user from directly contacting the litter. Thus, the present litterbox is hygienic and implements cost saving measures for the pet/animal owner.

### CROSS-REFERENCE TO RELATED APPLICATIONS

This application is a Non-Provisional application and claims priority to U.S. Provisional Patent Application No. 63/333,608 filed on Apr. 22, 2022, the entire disclosure of which is hereby incorporated by reference.

### FIELD OF THE EMBODIMENTS

The field of the embodiments relates to hygienic litter boxes that preserve unused litter to be reused as desired. In particular, the present invention and its embodiments provide for a litterbox system that allows for rotation of the litter box about an axis thereby screening the dirty/user litter from the clean litter to be reused.

### BACKGROUND OF THE EMBODIMENTS

The present invention and its embodiments relate to a litter box for a household pet or other animal. More particularly, the present invention relates to a litter box that is optimized for cleaning and reusing litter material. A litter box, such as a cat litter box, is typically a plastic or other material container having an opening. The litter box may be filled with litter such as a clumping cat litter type or a sand type material (e.g. clumping type material. A pet, such as a cat, can provide waste through the opening of the container and into the litter material. The waste can include feces as well as urine. The litter material reduces the aroma of the waste and absorbs the more liquefied forms of the waste. The litter box is emptied into a refuse container to remove the used litter material which is often unsightly and can have an offensive smell.

Typically, the removal of cat litter material from a litter box is an undesirable task due to the smell associated with the waste from the animal. Often, the pet owner can come in contact with excrement and used litter material as the litter material is dumped into the garbage and scooped from the litterbox. Additionally, a large amount of unused litter material is often wasted as the pet owner throws away the entire contents of the litter box, feces, and litter material associated with urination. Alternatively, the pet owner must scoop out the used litter material manually to save the remaining unused portions of the litter material.

### Review of Related Technology

U.S. Pat. No. 5,012,765 pertains to an improved animal waste collection and screening device having two litter pans in opposed orientation, an opened face of a first litter pan in facing arrangement with an open face of the second litter pan with a screen member in an interposed relationship between the opposing litter pans. Tracks on the screen member guide and receive the first pan on a first face side of the screen member and guide and receive the second pan on a second face side of the screen member, holding the two pans securely together. The screen member provides on one longitudinal end a handle and two catches, one catch for engaging each said litter pan when each said litter pan is fully received by said tracks and properly oriented with respect to the screen member and the respective other litter pan. The catches are located approximate to the handle for convenient one hand engagement and disengagement, and are self engaging and manually disengaging devices. The screening device including the pans and the screen member, can be composed of a molded plastic. Once both pans are engaged to the screen member, the entire device can be transported by a person using the handle for convenience.

U.S. Pat. No. 6,269,772 pertains to a cat litter system allows a pet owner to recycle unused cat litter without coming into contact with the used cat litter. The cat litter system includes a cover, a base and a screen. The cover engages the base over the screen. The system is rotated to pass unused cat litter through the screen into the cover which is then used as the base. The used cat litter is trapped by the screen and can easily be removed and thrown in a garbage receptacle.

U.S. Pat. No. 7,647,889 pertains to a litter box that has two unit assemblies and a waste receptacle. The first unit assembly has an unenclosed litter compartment; a compartment to temporarily hold filtered litter; and a pivotally mounted screen that filters out waste material from the litter. The second unit assembly is a support base having a motor mounted thereto that manipulates the first unit assembly, and contains a motion sensor and controller. The first unit assembly is partially rotated by the motor which causes litter and waste to move away from the litter compartment towards the temporary compartment. The screen filters litter and waste only allowing filtered litter to enter the temporary receptacle, forcing waste solids to pass by the temporary compartment into the waste receptacle. The motor reverses, and the filtered litter in the temporary receptacle is communicated back into the litter compartment by passing through and under or back through the screen.

U.S. Pat. No. 10,182,551 pertains to a fast and simple to use a sifting litter box. In an embodiment of the invention, the sifting litter box comprises two litter box trays oriented at a right angle with a screen placed in between the trays. Rotating the sifting litter box ninety degrees allows unused litter to sift through the screen while trapping clumped litter. The clumped litter can be discarded by removing the screen. Afterward, simply replace the screen back into the sifting litter box for the next cleaning cycle.

U.S. Patent Application 2015/0173324 pertains to a self-contained litter box comprising an attachable filtering mechanism for use in collecting waste matter from within the box thereby providing consumers with a simple and sanitary means of disposing pet waste either in a reusable plastic or a disposable/recyclable cardboard version.

Thus, there is a need for a litter box which allows a user to efficiently throw away only the used litter material. Additionally, there is a need for a litter box which does not require the homeowner to contact used litter material. The present invention and its embodiments meet and exceed these needs.

### BRIEF SUMMARY OF THE EMBODIMENTS

Described herein is a litter box that may be rotated or inverted about an arcuate surface thereby allowing the litter to be cleaned without throwing away all of the litter. In use, a user may use a screen member with a curved member attached thereto to position over a litter box to be cleaned. Once positioned over the opening of the litter box, a second litterbox is inverted and placed upon the first litter box thereby sandwiching the screen member therebetween. The litter box can then be rotated about an outer arcuate surface of the curved member. The litter will then pass through the screen member thereby capturing the waste (feces, clumped litter, etc.) and allowing the litter to pass into the second litter box. The second litter box is now ready to be used and the first litter box (with the waste) can now be cleaned or disposed of.

Further, this apparatus prevents a user from directly contacting the litter. Thus, the present litterbox is hygienic and implements cost saving measures for the pet/animal owner.

In one aspect, a litter box includes a first receptacle having a first end and a second end, a second receptacle having a first end and a second end, a curved member coupled to the second end of the first receptacle and the second end of the second receptacle, a screen member configured to cover an opening of the first receptacle and an opening of the second receptacle.

The litter box may also include further includes a first protrusion along a first edge of the screen member and a second protrusion along a second edge of the screen member.

The litter box may also include further includes a plurality of slots disposed in a body of the screen member.

The litter box may also include where the curved member is directly affixed to the screen member.

The litter box may also include where the first receptacle is positioned above the second receptacle.

The litter box may also include where the curved member is configured to allow the litter box to invert.

The litter box may also include where one of the first receptacle and the second receptacle contain litter.

In yet another aspect, a litter box includes a first receptacle having a first base, a plurality of first sidewalls, a first end, and a second end defining a first opening, a second receptacle having a second base, a plurality of second sidewalls, a first end, and a second end defining a second opening, a curved member having a screen member directly affixed to and protruding from the curved member, where the screen member is configured to cover at least one of the first opening of the first receptacle and the second opening of the second receptacle, where the screen member has a plurality of slots disposed in a body of the screen member.

The litter box may also include further includes a first handle and a second handle disposed on the screen member.

The litter box may also include where one of the first receptacle and the second receptacle contains litter.

The litter box may also include where when assembled the first opening of the first receptacle is oriented to be positioned over the second opening of the second receptacle.

The litter box may also include where when the litter box is inverted about the curved member the litter passes through the screen member.

The litter box may also include where each of the first handle and the second handle include an aperture.

The litter box may also include where the first protrusion and the second protrusion are located equidistant from a terminal edge of the screen member.

In another aspect, a litter box kit includes a first receptacle having a first base, a plurality of first sidewalls, a first end, and a second end defining a first opening, a second receptacle having a second base, a plurality of second sidewalls, a first end, and a second end defining a second opening, a curved member having an outer arcuate surface, a screen member directly affixed to and protruding from the curved member, where the screen member has a plurality of openings disposed in a body of the screen member, where, when assembled, the screen member is configured to cover at least one of the first opening of the first receptacle and the second opening of the second receptacle and the curved member is positioned at the second end of the first receptacle and the second end of the second receptacle.

In general, the present invention succeeds in conferring the following, and others not mentioned, benefits and objectives.

It is an object of the present invention to provide a litter box that is lightweight and easy to use.

It is an object of the present invention to provide a litter box that is hygienic.

It is an object of the present invention to provide a litter box that allows a user to reuse litter.

It is an object of the present invention to provide a litter box that prevents litter and smells from permeating the environment.

It is an object of the present invention to provide a litter box that is self-contained.

It is an object of the present invention to provide a litter box that is rotatable about an arcuate surface.

Other technical features may be readily apparent to one skilled in the art from the following figures, descriptions, and claims.

### BRIEF DESCRIPTION OF THE DRAWINGS

To easily identify the discussion of any particular element or act, the most significant digit or digits in a reference number refer to the figure number in which that element is first introduced.

FIG. 1 illustrates a perspective view of the litter box in accordance with one embodiment of the present invention.

FIG. 2 illustrates an exploded view of the litter box in accordance with one embodiment of the present invention.

FIG. 3 illustrates a top view of the litter box in accordance with one embodiment of the present invention with the top or second litter box removed.

FIG. 4 is a sectional side view of the litter box in accordance with one embodiment of the present invention.

FIG. 5A is a side view illustrating a rotational cleaning of the litter box in accordance with one embodiment of the present invention.

FIG. 5B illustrates an aspect of the subject matter in accordance with one embodiment.

### DETAILED DESCRIPTION OF THE EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

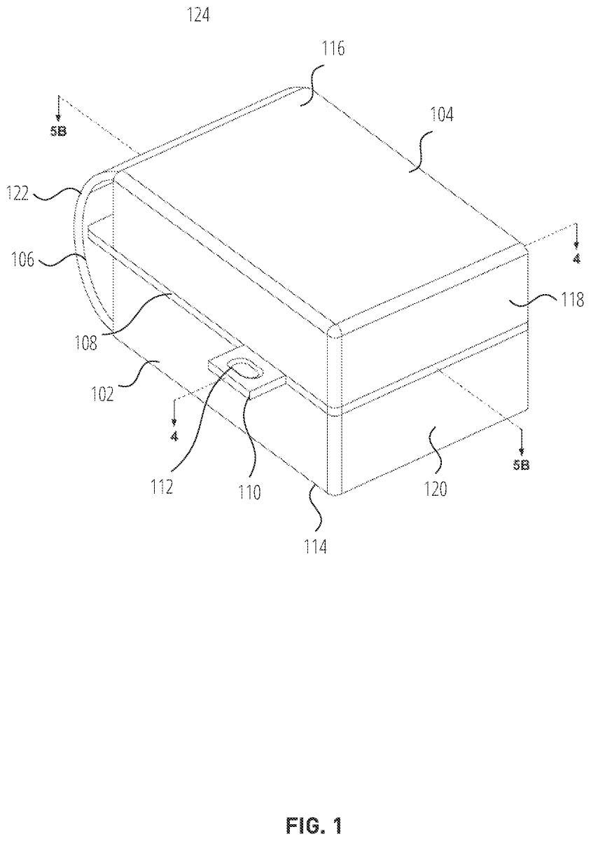

Referring now to FIG. 1, a litter box 124 consistent with the embodiments of the present invention may comprise a first receptacle 102, a second receptacle 104, a curved member 106, a screen member 108, a first handle 110, a second handle 208, an aperture 112, a first edge of screen member 202, a second edge of screen member 204, a plurality of slots 206, a first base 114, a second base 116, a plurality of first sidewalls 118, a plurality of second sidewalls 120, and an outer arcuate surface 122.

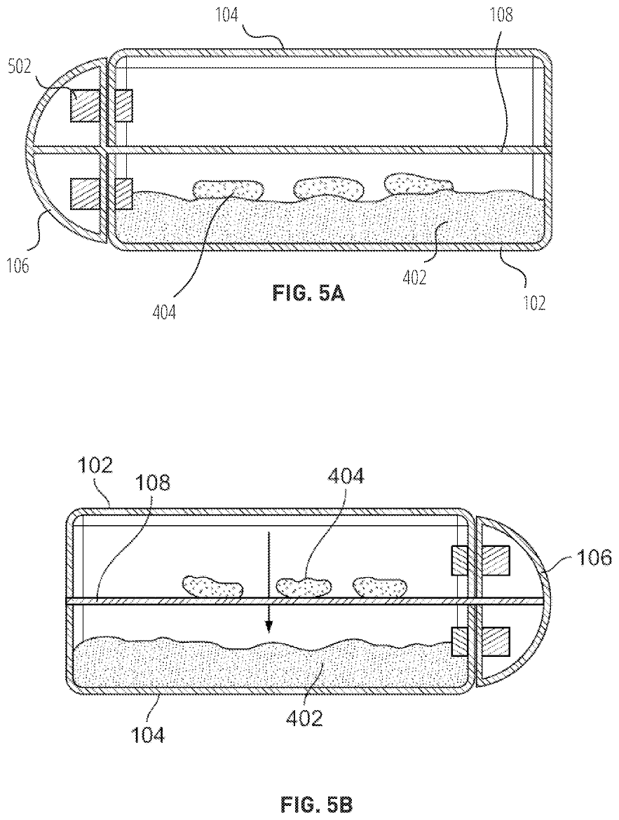

The litter box 124 comprises a first receptacle 102 and a second receptacle 104. The first receptacle 102 has a first base 114 and a first plurality of plurality of first sidewalls 118 defining an opening. The second receptacle 104 has substantially the same structure and may be structurally identical or different from the first receptacle 102. The first receptacle 102 may be comprised of almost any material including, but not limited to, polymers, metals, composites, and the like or some combination thereof. Additionally, in practice, only one of the first receptacle 102 and the second receptacle 104 are to be used at a time unless cleaning of the litter box 124 is occurring as shown in FIG. 5A.

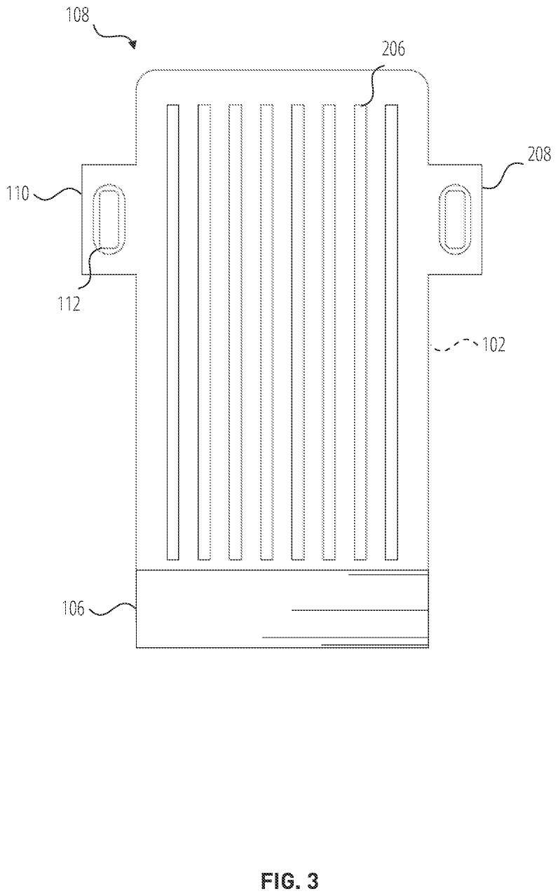

Further shown in FIG. 1 is the cleaning portion of the litter box 124. This cleaning portion comprises a curved member 106 and a screen member 108. The curved member 106 may be directly affixed to or separable from the screen member 108. Screen member 108 is more clearly shown in FIG. 3.

The curved member 106 has an outer arcuate surface 122 which extends in a direction opposite of that of the screen member 108. The outer arcuate surface 122 allows for rotation of the litter box 124 when being cleaned as shown in FIG. 5A. The curved member 106 may be made from a number of materials including, but not limited to wood, polymers, metals, composites, and the like or some combination thereof.

The screen member 108, as noted herein, is coupled to the curved member 106 and may be directly affixed to the curved member 106. The screen member 108 has a plurality of slots 206 that are intended to catch waste during the litter box 124 cleaning process. The plurality of slots 206 may be slots, openings of any shape or size, etc. The screen member 108 further has two handles comprising a first handle 110 and a second handle 208. The first handle 110 and the second handle 208 may be substantially identical in position and construct to one another. In other embodiments, the first handle 110 and the second handle 208 are of different constructs and/or positions from one another.

The first handle 110 and the second handle 208 may generally form protrusions suitable for griping the screen member 108 and/or the screen member 108 and curved member 106 combination. Each of the first handle 110 and the second handle 208 may have at least one aperture 112 as shown. Other configurations or arrangements in the size, shape, and/or number of apertures 112 may be utilized to further facilitate gripping and movement of the screen member 108 and/or curved member 106.

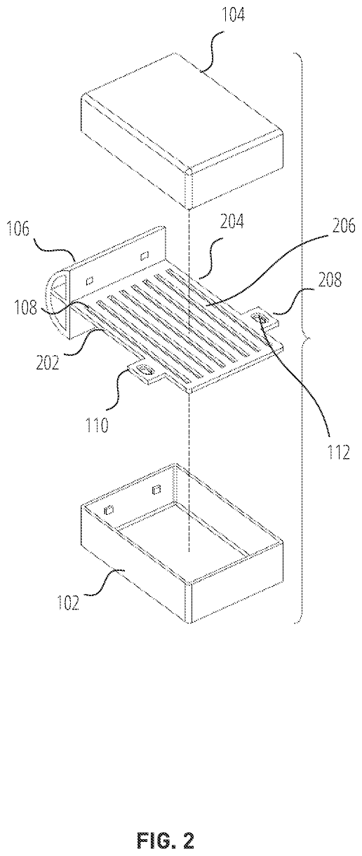

Referring now to FIG. 2, the litter box 124 is shown as an exploded view. As previously noted, the litter box 124 may comprise a first receptacle 102, a second receptacle 104, a curved member 106, a screen member 108, a first handle 110, a second handle 208, an aperture 112, a first edge of screen member 202, a second edge of screen member 204, a plurality of slots 206.

Here, it is evident how the components, notably, the first receptacle 102, second receptacle 104, curved member 106, and screen member 108 fit together. The first receptacle 102 is substantially identical to the second receptacle 104 and the screen member, during cleaning, fits between the two receptacles. The curved member 106 may be attached to the screen member 108 before or after the screen member 108 is fit between the two receptacles or the curved member 106 may be directly (e.g., permanently) affixed to the screen member 108. Additional mechanisms, such as but not limited to, clamps, snaps, buttons, vices, fasteners, etc. may be used to secure the position of the first receptacle 102, second receptacle 104, and the screen member 108/curved member 106 during the cleaning process.

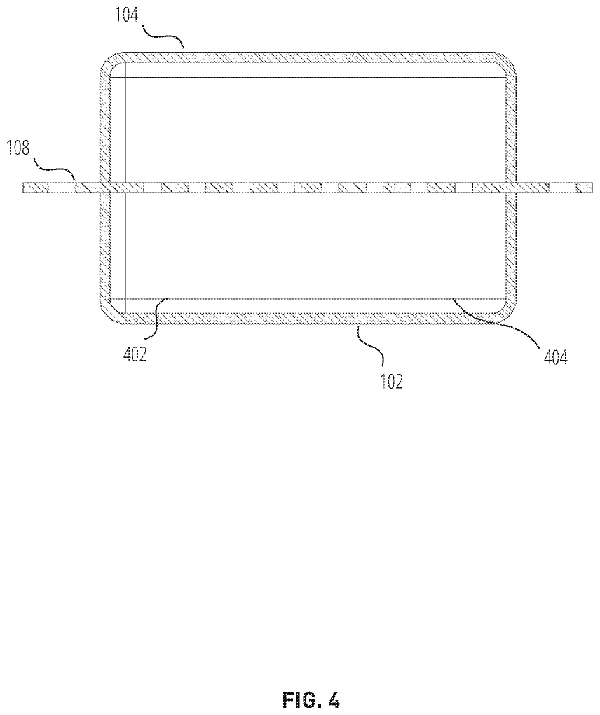

As shown in FIG. 3, the second receptacle 104 has been removed from the first receptacle 102 thereby allowing the screen member 108 and the position of the screen member 108 to be visible. The screen member 108 as shown rests upon the first receptacle 102. The screen member 108 and the first receptacle 102 may be shaped (e.g., complementary male/female structures) that allow for the screen member 108 to git securely with the first receptacle 102. In yet other embodiments, the curved member 106 attached or coupled to the screen member 108 may provide a sufficient amount of weight such that the screen member 108 is not easily moved from a position as the second receptacle 104 is applied or during the inverted cleaning process. The body of the screen member 108 has a plurality of slots 206 or other screening component that aligns with the opening of the first receptacle 102 such that litter 402 (see FIG. 4) may pass through once the paired receptacles are inverted for cleaning via the curved member 106.

A further sectional side view is shown of the litter box 124 in FIG. 4. Here, one can see the litter 402 and waste 404 in the first receptacle 102 before the entire system is rotated about the curved member 106 thereby allowing the litter 402 in the first receptacle 102 to be cleaned.

Additionally, it is evident how the first receptacle 102 and the second receptacle 104 are used in conjunction with each other during the cleaning process. The first first receptacle 102 and the second receptacle 104 both have a base and a plurality of sidewalls defining an opening. The opening of the first receptacle 102 faces upwards during use thereby allowing a cat or other animal to enter the first receptacle 102. The second receptacle 104 can then be coupled with the first receptacle 102 when the first receptacle 102 contains litter 402requiring cleaning. The second receptacle 104 is inverted, causing the opening of the second receptacle 104 to be paired with the opening of the first receptacle 102. This creates a closed system between the two receptacles that will allow for cleaning of the litter 402 of the first receptacle.

FIGS. 5A-5B demonstrates a preferred cleaning process for the litter box 124 system. Here, the litter box 124 is utilized as a first receptacle 102. The first receptacle 102 contains litter 402 which will eventually become soiled as the cat or other animal continues to use it. When is it time to clean the litter 402, the second receptacle 104 can be positioned upon the first receptacle 102 in order to form a closed system. However, a user should first position the curved member 106 bearing the screen member 108 between the first receptacle 102 and the second receptacle 104. The entire system may then be held together with a securing member 502 such as snaps, magnets fasteners, locks, friction fits, and the like or some combination thereof.

Once the first receptacle 102, second receptacle 104, and the curved member 106/screen member 108 are secured into position, the litter 402 is ready to be cleaned. A user may use the handles on the screen member 108 to rotate the combined first receptacle 102 and second receptacle 104 about an axis formed in part by the curved member 106.

As the entire system is rotated via the outer arcuate surface 122 of the curved member 106 the first receptacle 102 becomes inverted and the second receptacle 104 is positioned upon the ground. During the inversion process, the litter 402 passes through the plurality of slots 206 of the screen member 108 thereby leaving the first receptacle 102 and ending up residing in the second receptacle 104. This litter 402 is intended to be clean and ready for use by the cat or other animal.

The waste 404 comprising soiled litter, clumped litter, animal waste, etc. was filtered or screened during the inversion process by the screen member 108. It may be preferable to wait a length of time to allow the litter dust and other contaminants to settle, but once rotated (or inverted) the first receptacle 102 can be separated from the second receptacle 104, and the screen member 108/curved member 106 separated from the receptacles. The waste 404 should now be in the first receptacle 102 for disposal and cleaning of the first receptacle 102. The second receptacle 104 can now be utilized as a standalone litter box until the next round of cleaning is required.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A litter box comprising:
a first receptacle having a first end and a second end;
a second receptacle having a first end and a second end;
a curved member coupled to the second end of the first receptacle and the second end of the second receptacle;
a screen member configured to cover an opening of the first receptacle and an opening of the second receptacle.

2. The litter box of claim 1 further comprising a first protrusion along a first edge of the screen member and a second protrusion along a second edge of the screen member.

3. The litter box of claim 2 wherein the first protrusion and the second protrusion are located equidistant from a terminal edge of the screen member.

4. The litter box of claim 1 further comprising a plurality of slots disposed in a body of the screen member.

5. The litter box of claim 1 wherein the curved member is directly affixed to the screen member.

6. The litter box of claim 1 wherein the first receptacle is positioned above the second receptacle.

7. The litter box of claim 1 wherein the curved member is configured to allow the litter box to invert.

8. The litter box of claim 1 wherein one of the first receptacle and the second receptacle contains litter.

9. A litter box comprising:
a first receptacle having a first base, a plurality of first sidewalls, a first end, and a second end defining a first opening;
a second receptacle having a second base, a plurality of second sidewalls, a first end, and a second end defining a second opening;
a curved member having a screen member directly affixed to and protruding from the curved member,
wherein the screen member is configured to cover at least one of the first opening of the first receptacle and the second opening of the second receptacle,
wherein the screen member has a plurality of slots disposed in a body of the screen member.

10. The litter box of claim 9 further comprising a first handle and a second handle disposed on the screen member.

11. The litter box of claim 10 wherein each of the first handle and the second handle comprises an aperture.

12. The litter box of claim 9 wherein one of the first receptacle and the second receptacle contains litter.

13. The litter box of claim 12 wherein when the litter box is inverted about the curved member the litter passes through the screen member.

14. The litter box of claim 12 wherein when assembled the first opening of the first receptacle is oriented to be positioned over the second opening of the second receptacle.

15. A litter box kit comprising:
a first receptacle having a first base, a plurality of first sidewalls, a first end, and a second end defining a first opening;
a second receptacle having a second base, a plurality of second sidewalls, a first end, and a second end defining a second opening;
a curved member having an outer arcuate surface;
a screen member directly affixed to and protruding from the curved member,
wherein the screen member has a plurality of openings disposed in a body of the screen member;
wherein, when assembled, the screen member is configured to cover at least one of the first opening of the first receptacle and the second opening of the second receptacle, and the curved member is positioned at the second end of the first receptacle and the second end of the second receptacle.
